(19) United States
(12) Patent Application Publication
(10) Pub. No.: US 2026/0126693 A1
(43) Pub. Date: May 7, 2026

(54) OPTICALLY TRANSPARENT POLYMER ELECTROLYTE FILMS

(71) Applicant: DelStar Technologies, Inc., Alpharetta, GA (US)

(72) Inventor: Nandan Ukidwe, Suffield, CT (US)

(21) Appl. No.: 19/379,512

(22) Filed: Nov. 4, 2025

Related U.S. Application Data
(60) Provisional application No. 63/717,380, filed on Nov. 7, 2024.

(51) Int. Cl. G02F 1/1516; G02F 1/153

(52) U.S. Cl. CPC G02F 1/15165; G02F 1/1533

(57) ABSTRACT

Provided are electrolyte films or cells for use in variety of applications, such as electrochromic windows. An electrolytic film comprises a polymer layer, such as thermoplastic polyurethane or polymethyl methacrylate, and an electrolyte within the polymer layer. The electrolyte comprises a salt, a plasticizer and a tinting agent. The plasticizer and tinting agent comprise one or more materials that are selected to provide sufficient conductivity and optical transparency for operation of the electrolyte film in an application requiring substantial optical clarity and switching speed, such as a smart window.

### CROSS-REFERENCE TO RELATED APPLICATIONS

This application claims the benefit of U.S. Provisional Application Ser. No. 63/717,380, filed Nov. 7, 2024, the complete disclosure of which is incorporated herein by reference.

### TECHNICAL FIELD

This description generally relates to electrolyte films and more particularly to electrolyte films for use in electrochromic cells, such as those used in electrochromic windows.

### BACKGROUND

Electrochromic windows, also known as smart windows, are a new technology for energy efficiency in buildings that controls the amount of sunlight passing through. They can also produce less glare than fritted glass. Their efficiency depends on their placement, size, and weather, which affect the amount of sunlight exposure.

Smart windows with switchable light transmittance and reflectance are fast gaining popularity. They are very much tied into the emerging trend of sustainable, energy efficient dwellings. Among the different possible technologies for smart windows, electrochromism is one of the most promising. Electrochromism is a phenomenon where the color or opacity of a material changes depending on the application of voltage. Changing the light transmission properties in response to voltage allows for control over the amount of light and heat passing through. Once the change has been effected, no electricity is needed for maintaining the particular shade which has been reached. By doing so, an electrochromic window can block certain wavelengths of UV, IR or visible light on demand.

The basic structure of an electrochromic device or ECD typically embodies five superimposed layers on one substrate or positioned between two substrates in a laminated configuration. In this structure, there are three principally different kinds of layered materials in the ECD: electrochromic (EC) layers, transparent conductive layers and an electrolyte. The EC layers conduct ions and electrons and belong to the class of mixed conductors. The electrolyte layer is a pure ion conductor and separates the two EC layers. The transparent conductors are pure electron conductors. Optical absorption occurs when electrons move into the EC layers from the transparent conductors along with charge balancing ions entering from the electrolyte.

The ion conductive layer can be a liquid as is found in wet cell batteries. An example of such liquid ion conductive layer is propylene carbonate containing lithium perchlorate. One drawback with liquid electrolyte is that while it demonstrates acceptable ionic conductivity, it can leak out of the ECD, posing significant risk to end users. To solve this problem, the ion conductive layer can be a polymeric interlayer that is in solid state under ambient conditions. Examples of such solid-state ionic conductive layers are described in Ionic Conductivity of Polyether-Polyurethane Networks Containing Alkali Metal Salts. An Analysis of the Concentration Effect, Macromolecules, Vol. 17, No. 1, 1984, pgs. 63-66, to Killis, et al; and Poly(dimethylsiloxane)-Poly(ethylene oxide) Based Polyurethane Networks Used As Electrolytes in Lithium Electrochemical Solid State Batteries, Solid State Ionics, 15 (1985) 233-240, to Bouridah, et al., the complete disclosures of which are incorporated herein by reference in their entirely for all purposes.

While the solid polymeric interlayer electrolyte eliminates the possibility of electrolyte leakage, it suffers from poor ionic conductivity. One solution to this problem is to imbibe or plasticize the polymer with a liquid electrolyte to combine the mechanical benefits of a solid-state electrolyte with the high ionic conductivities of liquid electrolytes. For example, a thermoplastic urethane polymer can be plasticized with propylene carbonate containing a lithium salt. This film can be in solid state and with good mechanical strength under ambient conditions. Furthermore, it can also show a significant improvement in ionic conductivity compared to a film comprising the neat polymer containing the lithium salt additive. An example of this type of electrolyte is described in U.S. Pat. No. 8,673,503, the complete disclosure of which is incorporated herein by reference in its entirety for all purposes.

While films such as the one described above may work well in batteries or other applications, they are not optimized for smart windows because they are not sufficiently transparent. This is because the polymer and the plasticizer are not compatible with each other, i.e., they do not completely dissolve into each other in solution. For example, it has surprisingly been discovered that an optical grade polyether-based thermoplastic polyurethane polymer (i.e., Estane AG8451 from Lubrizol) plasticized with 43 phr propylene carbonate containing either 8.3 or 12.5% w lithium perchlorate (LiClO₄) develops significant haze under ambient conditions, although the resulting film shows good mechanical properties. Loss of optical clarity on account of incompatibility between the polymer and the liquid electrolyte makes such polymer electrolyte films of little value in electrochromic window applications.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present description generally relates to electrolyte films and more particularly to electrolyte films for use in electrochromic cells, such as those used in electrochromic windows. skylights, doors, sunroofs, mirrors, optical shutters, display devices, electrochromic glazing systems, safety laminate glass screens, dynamically tinting goggles, readable displays, helmet visors and other devices that can change optical characteristics as a result of an applied potential.

In one aspect, an electrolyte film comprises a polymer layer and an electrolyte within the polymer layer. The electrolyte comprises a salt and a plasticizer. The film further comprises a tinting agent in the polymer layer. The tinting agent and the plasticizer comprise one or more materials that are selected to provide sufficient conductivity and optical transparency for operation of the electrolyte film in an application requiring substantial optical transparency and switching speed, such as a smart window.

Suitable passive tinting agents include, but are not limited to, organic or inorganic pigments that are substantially evenly dispersed in a carrier resin that is compatible with the substrate. In embodiments, the passive tinting agents comprise inorganic pigments such as those belonging to anthraquinone, diazo benzimidazolone, isoindolinone, quinacridone and phthalocyanine families. Examples of inorganic pigments include iron oxides, bismuth vanadates, nickel antimony, ultramarine pigments, TiO₂ (white) and carbon black (black or gray).

In an exemplary embodiment, the passive tinting agent comprises carbon black. The carbon black may have an average particle size of about 50 nm to about 150 nm, or about 75 nm to about 125 nm, or about 90 nm to about 100 nm.

In embodiments, the tinting agent is present in the polymer layer in an amount of about 0.1 wt % to about 10.0% wt %, or about 0.5 wt % to about 5% wt %, or about 1.4 wt % to about 4. wt % based on the total weight of the polymer layer.

In embodiments, the polymer layer includes a polymer present in an amount of about 30 wt % to about 70 wt %, or about 40 wt % to about 60 wt %, or about 45 wt % to about 50 wt % based on the total weight of the polymer layer. The plasticizer is present in the polymer layer in an amount of about 30 wt % to about 70 wt %, or about 40 wt % to about 60 wt %. or about 45% to about 55%, or about 50 wt % based on the total weight of the polymer layer.

In embodiments, the plasticizer comprises one or more organic carbonates and a second plasticizer material embedded in the polymer layer. The organic carbonate and the second material are selected such that the Ra between the plasticizer and the polymer layer is less than about 5.0, preferably less than or equal to about 3.79. Ra is defined herein as the Hansen Solubility Parameter, which generally represents the overall compatibility of two materials to dissolve into one another and form a solution. Applicant has discovered that the Hansen Solubility Parameter is a reliable measure of the overall optical clarity of two or more co-solvents.

The organic carbonate and the second material are also selected to provide an ionic conductivity through the electrolyte film of at least about 1.5×10⁻⁵ Siemens/cm, or at least about 3.93×10⁻⁴ Siemens/cm. In certain embodiments, the materials of the plasticizer are selected to have a haze of about 2% or less as measured by ASTM D1003-13.

Suitable materials for the organic carbonate include, but are not limited to, diethyl carbonate, propylene carbonate, ethylene carbonate, gammabutryrolactone, dimethyl carbonate, methyl ethyl carbonate, glycerin carbonate, butylene carbonate, alkylene carbonate and combinations thereof. In an exemplary embodiment, the organic carbonate is selected from the group consisting of diethyl carbonate, propylene carbonate and ethylene carbonate.

Suitable materials for the second material include, but are not limited to, a benzoate, a monobenzoate, a dibenzoate, an acrylate monomer, a phthalate, an aliphatic ester, a non-aliphatic ester, an ethylene glycol bis, a trimellitate, a sebacate, an adipate, a terephthalate, a gluterate, a glyceride, an azelate, a maleate, an epoxidized soybean oil, glycols and/or polyether, triethylene glycol dihexanoate (3G6), tetraethylene glycol diheptanoate (4G7), triethylene glycol bis(2-ethyl hexanoate) (TEG-EH), tetra ethylene glycol bis(2-ethyl hexanoate) (4GEH), polyethylene glycol bis(2-ethylhexanoate) (PEG-EH), an organophosphate tricresyl phosphate (TCP), tributyl phosphate (TBP), alkyl citrates, glycerol, acetylated monoglycerides and combinations thereof. Applicant has found that a combination of an organic carbonate with one or more of these materials at certain volume percentages reduces the overall Ra between the plasticizer and the polymer, thereby increasing the optical clarity of the electrolyte film.

In one embodiment, the plasticizer comprises an organic carbonate and triethylene glycol bis(2-ethyl hexanoate) (TEG-EH). In an exemplary embodiment, the organic carbonate comprises propylene carbonate. In another embodiment, the plasticizer may include a combination of ethylene carbonate, propylene carbonate, and triethylene glycol bis(2-ethylhexanoate) (TEG-EH).

In embodiments, the second material has a volume percentage of about 20% to about 80%, or about 20% to about 40%, or about 30% to about 35% or about 34% based on the total weight of the plasticizer. The organic carbonate has a volume percentage of about 20% to about 80%, or about 60% to about 80% or about 65% to about 70%, or about 66% based on the total weight of the plasticizer.

The salt preferably comprises an alkali or alkaline earth metal salt, such as lithium salt or salts with cations having the elements of Na, K, Cs, Mg and Ag. Suitable lithium salts include, but are not limited to, lithium chloride (LiCl), lithium fluoride (LiF), lithium iodide (LiI), lithium nitrate (LiNO₃), lithium perchlorate (LiClO₄), lithium tetrafluoroborate (LiBF₄), lithium hexafluorophosphate (LiPF₆), lithium hexafluoroarsenat (V) (LiAsF₆), lithium triflate, lithium imide, lithium bis(trifluoromethanesulfonyl)imide (LiTFSI) salt, lithium 2-trifluoromethyl-4,5-dicyanoimidazolide (LiTDI), or a combination thereof.

The polymer layer may comprise any suitable polymer that provides sufficient transparency to visible light and exhibits suitable adhesion to the other surfaces of the electrochromic film which the polymer may contact. Suitable polymers include thermoplastic polymers or acrylic polymers, such as polymethyl methacrylate (PMMA). In preferred embodiments, the polymer comprises a thermoplastic polymer, such as thermoplastic polyurethane (TPU). In an exemplary embodiment, the polymer comprises a thermoplastic polyurethane, such as an aliphatic polyether thermoplastic polyurethane or a blend of two or more aliphatic polyether thermoplastic polyurethanes.

In embodiments, the polymer comprises a material having a durometer or Shore hardness of greater than 80A, or greater than 87A, or greater than or equal to 51D, or greater than or equal to 55D, or greater than or equal to about 60D, or greater than or equal to 67D, or greater than or equal to 72D, or greater than or equal to 80D. Shore hardness was measured according to the ASTM D2240.

In embodiments, the electrolyte film has no creep as measured according to the procedures described herein and/or ASTM C1172, at about 85° C. for at least 24 hours.

The electrolyte may be a solid, liquid or a gel. In embodiments, the salt is plasticized or otherwise embedded within the polymer layer by the organic solvent, forming a liquid or gel electrolyte. In an exemplary embodiment, the polymer layer comprises a liquid electrolyte concentration of at least about 30% by weight of the polymer layer, or at least about 40% by weight of the polymer layer, or at least about 45% by weight of the polymer layer, or at least about 50% by weight of the polymer layer. Applicant has discovered that increasing liquid electrolyte concentration increases the conductivity of the electrolyte while maintaining little to no creep at high temperatures.

In another embodiment, the plasticizer comprises two or more organic carbonates, such as diethyl carbonate, propylene carbonate or ethylene carbonate, that are mixed together. Applicant has discovered that a selected mixture of two or more such organic carbonates reduces the overall Ra between the plasticizer and the polymer, thereby increasing the optical clarity of the electrolyte film. In one such embodiment, the plasticizer comprises a mixture of diethyl carbonate and propylene carbonate that provides sufficient conductivity and optical clarity to the electrolyte film. In an exemplary embodiment, the mixture contains of about 40% to 90% by volume of the propylene carbonate, more preferably about 50% to about 85% by volume, with the remainder of the mixture substantially comprising diethyl carbonate.

In another aspect, an electrochromic cell comprises first and second layers of an optically transparent material and an electrolyte film between the first and second layers. The electrolyte film comprising a polymer layer, a plasticizer and a tinting agent.

The plasticizer and the tinting agent are selected such that the electrochromic cell has a switching speed from a first state to a second state of less than about 6 minutes, or about 3 minutes. The first state has a greater light transmittance than the second state. In an exemplary embodiment, the first state is a “clear or fully bleached” state and the second state is a “shaded, dark or fully colored” state. As used herein, the term or expression “switching speed” may refer to the time elapsed for an electrochromic device to change from the optical density thereof from a fully bleached state to a fully colored state.

In embodiments, the electrochromic cell has a light transmittance (as measured according to reference test ASTM-D1003) of less than about 60%, or less than about 50%, or less than about 30%, in the first or clear state. The electrochromic cell may have a light transmittance of less than about 15%, or less than about 10% or less than about 5% in the second or shaded state.

In embodiments, the electrolyte film comprises an ion conductive layer. The electrochromic cell may further include first and second electrochromic layers disposed between the first and second layers of optically transparent material and the ion conductive layer. The cell may further include a layer of transparent conductive oxide between each of the first and second layers of optically transparent material and the first and second electrochromic layers.

In another aspect, a window, such as a smart window, skylight, door, sunroof or the like, is provided that comprises an electrochromic cell, such as that described above.

The recitation herein of desirable objects which are met by various embodiments of the present description is not meant to imply or suggest that any or all of these objects are present as essential features, either individually or collectively, in the most general embodiment of the present description or in any of its more specific embodiments.

### BRIEF DESCRIPTION OF THE DRAWINGS

FIG. 1 is a schematic view of an electrochromic cell for a window;

FIG. 2 is a graph of light transmission versus passive tinting concentrate loading; and

FIG. 3 are photographs of three electrochromic cells laminated to a glass, illustrating light transmittance in a clear state (bottom row) and a shaded state (top row).

### DETAILED DESCRIPTION OF THE EMBODIMENTS

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting. Any molecular weight or molecular mass values are approximate and are provided only for description.

While the following description is presented with respect to electrochromic devices or ECDs for windows, it should be understood that devices and methods disclosed herein may be readily adapted for use in a variety of other applications, such as skylights, doors, sunroofs, mirrors, optical shutters, color changeable eyewear, welding visors, aircraft windows, display devices, electrochromic glazing systems, safety laminate glass screens for automobiles and the like, dynamically tinting goggles, readable displays, helmet visors, paper for drawing on with a stylus, and other devices that can change optical characteristics or more generally electromagnetic transmission as a result of an applied potential.

Typically, ECDs are of two types depending on the modes of device operation, namely the transmission mode and the reflectance mode. In the transmission mode, the conducting electrodes are transparent and control the light intensity passing through them; this mode is typically used in smart-window applications. In the reflectance mode, one of the transparent conducting electrodes (TCE) is replaced with a reflective surface like aluminum, gold or silver, which controls the reflective light intensity; this mode is useful in the rear view mirrors of cars and EC display devices.

Electrochromic devices can also be categorized in two types depending upon the kind of electrolyte used. Laminated ECDs incorporate liquid gels, while solid electrolyte ECDs incorporate solid inorganic or organic material. The basic structure of electrochromic device embodies five superimposed layers on one substrate or positioned between two substrates in a laminated configuration.

The ECD typically includes five layers positioned between two substrates, such as glass, or flexible polyester foils. The central part of the device is an ion conductor termed an electrolyte that ensures that ions exchange between two electrode materials. Upon application of an electric field, one of the electro-active materials is reduced while the other one is oxidized leading to a change of color or opacity of at least one of them, which induces a change in coloration or opacity in the entire ECD device.

The electrolyte film described herein comprises a polymer layer and an electrolyte within the polymer layer. The electrolyte comprises a salt and a plasticizer. The film further comprises a tinting agent in the polymer layer. The tinting agent and the plasticizer comprise one or more materials that are selected to provide sufficient conductivity and optical transparency for operation of the electrolyte film in an application requiring substantial optical transparency and switching speed, such as a smart window.

In embodiments, the plasticizer comprises one or more organic carbonates and a second plasticizer material embedded with the salt in the polymer layer. Applicant has previously discovered that the use of a second plasticizer improves the compatibility between the solid polymer matrix and the primary liquid plasticizer. For example, a 50/50v blend of Benzoflex 9-88 and propylene carbonate or a 66/34v blend of propylene carbonate and TEG-EH does not cause haze when melt compounded with an Estane AG8451 polymer (an aliphatic TPU). Benzoflex 9-88 SG is a trade name for 3,3′-Oxybis(1-propanol) dibenzoate plasticizer and TEG-EH stands for triethylene glycol bis(2-ethylhexanoate). Both plasticizers are available from Eastman Chemicals Company. Triethylene glycol bis(2-ethylhexanoate) is also available from Celanese and Proviron under the trade names Celanese PLX and Proviplast 1783 respectively. It should be possible for those skilled in the art to select other organic carbonates and cosolvents such that the resulting plasticizer blend can be melt blended with aliphatic TPUs without causing significant haze. Examples of cosolvents may include but are not limited to other dibenzoate plasticizers such as Benzoflex 352, Benzoflex 2088, Benzoflex 50 etc., other phthalate plasticizers such as diisobutyl phthalate, diisononyl phthalate etc., other non-phthalate plasticizers such as 1,2-cyclohexane dicarboxylic acid diisononyl ester (DINCH), other non-aromatic plasticizers such as triethylene glycol bis(2-ethylhexanoate) (TEG-EH), tetraethylene glycol bis(2-ethylhexanoate), polyethelene glycol bis(2-ethylhexanoate) (PEG-EH) etc. A more complete description of suitable cosolvents can be found in commonly assigned U.S. Pat. No. 12,032,260, the complete disclosure of which is incorporated herein by reference for all purposes.

It was also surprisingly and unexpectedly discovered that utilizing a polymer having a Shore hardness of greater than 80A or greater than 87A, and a plasticizer in an amount of about 35 wt % resulted in no creep when adhered to a substrate at the same elevated temperature. The results of no creep were demonstrated with the polymer having a Shore hardness of greater than 80A or greater than 87A, and varying plasticizers. It was further surprisingly and unexpectedly discovered that increasing the amount of the plasticizer to about 50 wt % resulted in a significant increase in ion conductivity as compared to polymeric ion conductive layers including the plasticizer in an amount of about 35 wt % at the same ambient temperature. A more complete description of these polymers and plasticizers can be found in commonly assigned U.S. Provisional Application Ser. No. 63/593,685, the complete disclosure of which is incorporated herein by reference for all purposes.

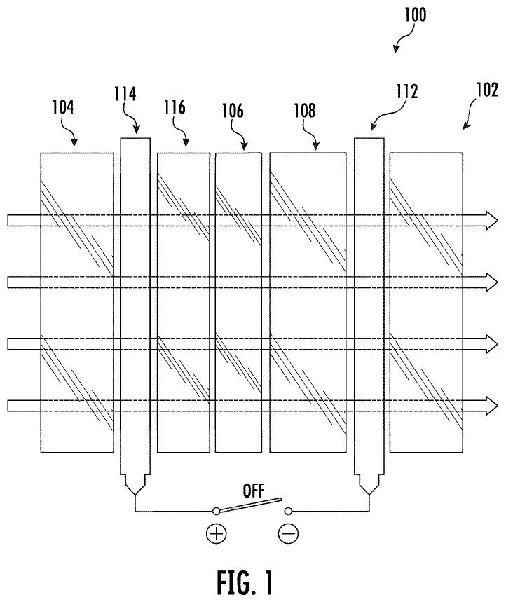

The formulations described in U.S. Pat. No. 12,032,260 and U.S. 63/593,685, when laminated between conductive electrodes as shown in FIG. 1, produce light transmittance in the 60-70% range in the clear state (Tclear) and approximately 10-15% in the shaded state (Tdark).

For example, Sample 1 produced a light transmittance of 65% in the clear state and 10% in the shaded state after more than 3,000 cycles under ambient conditions. The same sample produced light transmittance of 62% in the clear state and 13% in the shaded state after more than 2,100 Q-SUN cycles. The switching speed was reported to be approximately 6 minutes under both ambient and Q-SUN conditions.

Sample 2 produced a light transmittance of 68% in the clear state and 10% in the shaded state after more than 500 cycles under ambient conditions. The same sample produced light transmittance of 65% in the clear state and 13% in the shaded state after more than 1,500 Q-SUN cycles. The switching speed was reported to be approximately 6 minutes under both ambient and Q-SUN conditions.

Sample 3 produced a light transmittance of 70% in the clear state and 10% in the shaded state after more than 700 cycles under ambient conditions. The same sample produced light transmittance of 70% in the clear state and 10% in the shaded state after more than 880 Q-SUN cycles. The switching speed was reported to be approximately 6 minutes under both ambient and Q-SUN conditions when the sheet moisture was approximately 250 ppm. Sample A was cast on a 5 mil polypropylene carrier and employed a blue interleaf.

Sample 4 produced on Line 11 TSE Trial on Mar. 14, 2024, produced a light transmittance of 67% in the clear state and 10% in the shaded state after more than 700 cycles under ambient conditions. The same sample produced light transmittance of 67% in the clear state and 10% in the shaded state after more than 300 Q-SUN cycles. The switching speed was reported to be approximately 6 minutes under both ambient and Q-SUN conditions when the sheet moisture was approximately 470 ppm. Sample C was cast on a 5 mil polypropylene carrier and employed a 5 mil polypropylene carrier on the other side.

All samples comprised 50% w Elastollan L760D and 50% w Gen 1 plasticizer. Gen 1 plasticizer is further defined as a 66/34v propylene carbonate/TEG-EH plasticizer blend containing 1M LiTFSI salt. Furthermore, Sample 1 yielded an ionic conductivity of 3.93×10⁻⁴ S/cm without any additional drying. Samples 4 and 4 yielded an ionic an ionic conductivity of approximately 1.5×10⁻⁵ S/cm when dried to a moisture content of less than 2,000 ppm.

As seen from the above samples, the light transmittance window was fairly repetitive and fixed, i.e., in the 60-70% range in the clear state and the 10-15% range in the shaded state. None of these formulations allowed maximum light transmittance (Tclear) to be less than 60% or the minimum light transmittance (Tdark) to be less than 10%. It is conceivable that the market may demand a laminated glazing that caps the Tclear to be less than 60% or less than 50% or less than 30% and the Tdark to be less than 15% or less than 10% or less than 5% without jeopardizing other critical attributes such as switching speed or weatherability. Examples of such laminated glazing applications include but are not limited to sunroofs of automobiles or window in commercial constructions.

Applicant has surprisingly discovered that the addition of a passive tinting additive to the electrolyte layers described above can enable electrochromic interlayer formulations with significantly enhanced flexibility with respect to the light transmission window without jeopardizing switching speed or weatherability. In fact, Applicant has discovered that a passively tinted and ionically conductive polymer interlayer can offer additional flexibility to adjust the switching window between various states, such as a clear or fully bleached state and a dark or fully colored state. The shaded or dark versus clear or bleached states are defined as per following typical electrochemical system: Li_{y}NiOₓ (clear)+WO₃ (clear)↔Li_{y-z}NiOₓ (dark)+Li_{z}WO₃ (blue). Application of voltage leads to shaded or dark state due to coloration of both cathodic and anodic oxide layers as Li⁺ migrates into the WO₃ layer, and reversal of voltage leads to clear or bleached state as Li⁺ ions migrate back to Li_{y}NiOₓ layer. A clear or bleached state or a shaded or dark state is ultimately defined by the maximum or the minimum in the light transmission and corresponds to Li⁺ being maximally on the NiOₓ or WO₃ side of the above equilibrium respectively [Ref: Cheng et al., iScience 10, 80-86 Dec. 21, 2018].

Suitable passive tinting agents include, but are not limited to, organic or inorganic pigments that are evenly dispersed in a carrier resin that is compatible with the substrate. In embodiments, the passive tinting agents comprise in organic pigments due to their superior color fastness in outdoor applications and the ease with which they can be dispersed in the base resin. Suitable organic pigments, includes those belonging to anthraquinone, diazo benzimidazolone, isoindolinone, quinacridone and phthalocyanine families. Examples of inorganic pigments include iron oxides, bismuth vanadates, nickel antimony, ultramarine pigments, TiO₂ (white) and carbon black (black or gray).

In an exemplary embodiment, the passive tinting agent comprises carbon black due to its light fastness, resistance to solvents, chemical stability and heat stability. The carbon black may have an average particle size of about 50 nm to about 150 nm, or about 75 nm to about 125 nm, or about 90 nm to about 100 nm.

In embodiments, the tinting agent is present in the polymer layer in an amount of about 0.1% to about 10.0% wt %, or about 0.5% to about 5% wt %, or about 1.4% to about 4.5% wt % based on the total weight of the polymer layer.

FIG. 1 illustrates an exploded cross-sectional view of an exemplary electrochromic cell or device 100, according to one or more implementations described. The electrochromic device 100 may include one or more substrates, which may be optically transparent layers or sheets, and electrochromic layers disposed on the substrate or interposed between the substrates. For example, the electrochromic device 100 may include one or more optically transparent layers or sheet 102, 104, one or more electrochromic (EC) layers 106, 108, one or more transparent oxide layers 110, 112, one or more ion conductive layers 114, or any combination thereof. As illustrated in FIG. 1, the electrochromic device 100 may include two optically transparent layers 102, 104, two EC layers 106, 108 interposed between the optically transparent layers 102, 104, two transparent oxide layer 110, 112 interposed between the optically transparent layers 102, 104, and an ion conductive layer 114 interposed between the EC layers 106, 108. It should be appreciated that each of the components of the electrochromic device 100, the orientation or disposition thereof, and the respective functions thereof are known to one having ordinary skill in the art.

The optically transparent layers 102, 104 may include any suitable transparent and/or rigid material, and may be selected, at least in part, by the application for the electrochromic device 100. For example, each of the optically transparent layers 102, 104 may independently be or include, but is not limited to, glass, polycarbonate, tempered glass, laminated glass, engraved glass, polymeric sheet, a rigid outer ply, a ceramic, an acrylic, polyethylene terephthalate (PET), a polyphosphonate, or the like, or any combination thereof.

The EC layers 106, 108 may be or include mixed conductors that may be capable of or configured to conduct ions and electrons. The EC layers 106, 108 may be or include, but are not limited to, transition metal oxides, transition metal complexes, conducting polymers, viologens, polyaniline, polythiophene, tungsten oxide (WO₃), Prussian Blue, or the like, or any combination thereof. At least one of the EC layers 106, 108 may be or include a cathodic electrochromic conducting polymer, and at least one of the EC layers 106, 108 may be or include an anodic electrochromic conducting polymer. For example, a first EC layer 106 may be or include the anodic electrochromic conducting polymer, and a second EC layer 108 may be or include the cathodic electrochromic conducting polymer. Illustrative anodic electrochromic conducting polymers may be or include, but are not limited to, bis(2-(3,4-ethylenedioxy) thienyl)-N-methyl carbazole polymer (BEDOT-NMCz), PPro-NPrS, derivatives thereof, or the like, or any combination thereof. Illustrative cathodic electrochromic conducting polymers may be or include, but are not limited to, PEDOT, PProDOT, PEDOP, PTT, PAEM-EDOT, or the like, or any combination thereof.

The transparent oxide layers 110, 112 may be disposed adjacent the optically transparent layers 102, 104, respectively. The transparent oxide layers 110, 112 may be or include any suitable material capable of or configured to conduct electrons, such as metal oxides. The transparent oxide layers 110, 112 may have a relatively low absorption of light. Illustrative transparent oxide layers 110, 112 may be or include, but are not limited to, indium oxide, indium tin oxide, silicon oxide, or the like, or any combination thereof. The transparent oxide layers 110, 112 or the metal oxides thereof may be doped with one or more of fluorides, antimony, or aluminum to improve the conductivity thereof. It should be appreciated that other transparent conductive materials may be utilized for the transparent oxide layers 110, 112, including, but not limited to, PEDOT/PSS, carbon nanotube, coatings or layers thereof, or any combination thereof.

The ion conductive layer 114 may be capable of or configured to provide a medium for the exchange of ions between two or more electrodes or electrode materials. The ion conductive layer 114 may be or include one or more polymers, one or more electrolytes, one or more salts, one or more plasticizers, or any combination thereof. For example, the ion conductive layer 114 may be a polymeric ion conductive layer including a combination of one or more polymers, one or more electrolytes, and one or more plasticizers.

In certain embodiments, the polymer, salt and plasticizer may be dissolved into a precursor material, such as Tetrahydrofuran (THF) or oxolane, or similar type precursors. Applicant has found that using coating chemistry allows for thinner films to be manufactured which, in turn, increases the ionic conductivity of the film.

The polymeric ion conductive layer 114 may be a solid or a gel. In an exemplary embodiment, the polymer layer comprises a liquid electrolyte concentration of at least about 30% by weight of the polymer layer, or least about 40% by weight of the polymer layer, or at least about 45% by weight of the polymer layer, or at least about 50% by weight of the polymer layer. Applicant has discovered that increasing liquid electrolyte concentration increases the conductivity of the electrolyte while maintaining little to no creep at high temperatures.

All components of the electrolyte form a homogenous, generally colorless and crystal-clear composition. The conductive salt is completely dissolved within the polymer. The materials of the ECD are also selected to provide sufficient extrudability such that the materials can be extruded together to form the final ECD device. Extrudability is the power required to push or force something through an extruder, such single and twin-screw machines, co-rotating or counterrotating, closely intermeshing twin-screw compounders and the like. The mean extrusion force for one or more materials can be tested under standard methods of applying force to the materials until they flow through an outlet (or a plurality of outlets) that may be in the form of one or more slots or holes. The materials are compressed until the structure of the product is disrupted and it extrudes through the outlets. Applicant has determined that higher levels of plasticizer may adversely affect both ionic conductivity and extrudability of the liquid plasticizer and polymer. Thus, the materials selected in herein provide sufficient optical transparency, as well as conductivity and extrudability.

In an exemplary implementation, the polymeric ion conductive layer 114 includes one or more polymers or polymer blends, and a plasticizer and a salt dispersed or otherwise combined with the one or more polymers or polymer blends. The salt may be capable of or configured to provide electrolyte properties to the polymeric ion conductive layer 114. The salt may be combined with the one or more plasticizers prior to combining with the polymer or polymer blend. The salt may be combined with the plasticizer via one or more solvents, such as an organic solvent and/or an aqueous solvent. The salt may be present in an amount of from about 1 wt % to about 25 wt %, based on the total weight of the polymeric ion conductive layer 114. The salt may be combined with the plasticizer in an amount of from about 0.1M to about 2M. The plasticizer may be present in an amount of from about 5 wt % to about 65 wt %, based on the total weight of the polymeric ion conductive layer 114. The one or more polymers and/or the polymer blends may make up the balance of the polymeric ion conductive layer 114. Each of the components of the polymeric ion conductive layer 114 may form a homogenous, generally colorless, and/or clear composition.

The polymeric ion conductive layer 114 may have a thickness that depends, at least in part, on the application of the electrochromic device 100 or one or more components thereof. In at least one implementation, the polymeric ion conductive layer 114 may have a thickness of from about 100 μm to about 2000 μm. For example, the polymeric ion conductive layer 114 may have a thickness of from about 100 μm to about 2000 μm, about 100 μm to about 1500 μm, or about 150 μm to about 1000 μm.

The components of the polymeric ion conductive layer 114 may be selected to provide sufficient mechanical, conductive, and/or optical properties. For example, the components of the polymeric ion conductive layer 114 may provide an ionic conductivity sufficient for a switching speed of less than 6 minutes (min), less than 3 min, less than 1 min, or less than 30 seconds. As used herein, the term or expression “switching speed” may refer to the time elapsed for an electrochromic device to change from the optical density thereof from a fully bleached state to a fully colored state.

In an exemplary embodiment, The plasticizer and the tinting agent are selected such that the electrochromic cell has a switching speed from a first state to a second state of less than about 6 minutes, or about 3 minutes. The first state has a greater light transmittance than the second state. In an exemplary embodiment, the first state is “clear or fully bleached” state and the second state is a “shaded, dark or fully colored” state.

In another example, the components of the polymeric ion conductive layer 114 may provide sufficient mechanical adhesion to one or more components of the electrochromic device 100 such that there is no or minimal creep therebetween. The polymeric ion conductive layer 114 may have no or substantially no creep, as measured according to the procedures described herein and/or ASTM C1172, at about 85° C. For example, the polymeric ion conductive layer 114 may not have any creep or displacement when measured according to the procedures described herein and/or ASTM C1172, at about 85° C. The creep may be measured at temperatures of about 85° C. or more for at least 24 hours.

The polymeric ion conductive layer 114 may have an ionic conductivity of about 1E-6 Siemens/cm (S/cm) or greater. For example, the polymeric ion conductive layer 114 may have an ionic conductivity of from greater than or equal to about 1E-6 S/cm, greater than or equal to about 1E-5 S/cm, or greater than or equal to about 1E-4 S/cm. In certain embodiments, the ionic conductivity through the electrolyte film is at least about 1.5×10⁻⁵ Siemens/cm, or at least about 3.93×10⁻⁴ Siemens/cm.

Transmittance refers to the ratio of the radiant power transmitted through a material or device to the incident radiant power. Transmittance is usually expressed as a percent. For example, an electrochromic device with a 50% transmittance (at a specific wavelength) will absorb half of the light incident upon it and allow half of it to pass through. The polymeric ion conductive layer 114 may have a light transmittance (as measured according to reference test ASTM-D1003 of the American Society for Testing and Materials (ASTM)) of less than about 60%, or less than about 50%, or less than about 30%, in the first or clear state. The electrochromic cell may have a light transmittance of less than about 15%, or less than about 10% or less than about 5% in the second or shaded state.

The optical transparency of an ECD can also be evaluated based on the “haze” seen when light is transmitted through the ECD. Haze be measured with a haze meter, which typically includes a fiber optic spectrometer, a light source with integrated optical amplification and collimating lens and a custom haze measurement sphere with diffuse transmission port and sample clips. The polymeric ion conductive layer 114 may have a haze, as measured according to reference test ASTM-D1003 of the American Society for Testing and Materials (ASTM), of less than or equal to about 5%. For example, the polymeric ion conductive layer 114 described herein may have a haze, as measured according to ASTM-D1003 of less than or equal to about 5%, less than or equal to about 4%, less than or equal to about 3%, less than or equal to about 2%, less than or equal to about 1%, or less than or equal to about 0.7%.

The polymeric ion conductive layer 114 may have a peel strength of greater than 25 N/mm, as measured according to ASTM D 3167. For example, the polymeric ion conductive layer 114 may have a peel strength of greater than 25 N/mm, greater than 30 N/mm, greater than 35 N/mm, greater than 40 N/mm, or more.

The polymeric ion conductive layer 114 may include one or more fillers. Illustrative fillers may be or include, but are not limited to, particles having an average particle size of from about 1 nm to about 20 μm. The filler be present in an amount and/or have a particle size sufficient to provide the polymeric ion conductive layer 114 a light transparency of greater than 80%. Illustrative fillers may be or include, but are not limited to, polystyrene, polycarbonate, PMMA, glass powder, glass nanoparticles, inorganic oxides, mixed oxides, or the like, or any combination thereof.

The performance of the electrochromic device 100 may be evaluated in terms of switching times and transparency (or transmission contrast) under different humidity and temperature conditions. These electrochromic devices 100 may be tested at reduced pressures. A cycling voltage to operate the electrochromic device 100 may be determined by cycling the electrochromic device 100 at different voltages and monitoring changes in the % T in the clear state after a number of cycles. Potential cycling or stepping may be used to identify the preferred device voltage for a desired operating life.

The one or more components of the electrochromic device 100 may also be selected to provide sufficient extrudability such that the composition of the electrochromic device 100 may be extruded with one another together to form the final electrochromic device 100. For example, the components of the EC layers 106, 108, the transparent oxide layers 110, 112, and/or the ion conductive layers 114 may be selected such that the combination may be extruded on the optically transparent layers 102, 104 to prepare the electrochromic device 100. Extrudability is the energy sufficient to push or force something through an extruder, such single and twin-screw machines, co-rotating or counterrotating, closely intermeshing twin-screw compounders or the like. The components selected in herein provide sufficient optical transparency, ion conductivity, adhesion, and extrudability.

The one or more polymers or polymer blends of the polymeric ion conductive layer 114 may be capable of or configured to provide sufficient transparency or transmission of visible light, suitable adhesion to a substrate or component of the polymeric ion conductive layer 114, and/or ionic conductivity. Illustrative polymers and polymer blends may be or include, but are not limited to, one or more of a thermoplastic polymer, an acrylic polymer, such as polymethylmethacrylate (PMMA), polyolefins, polyesters, polycaprolactones, such as polyethylene terephthalate or polybutylene terephthalate, a thermoset polymer, or the like, or blends thereof, or any combination thereof. In an exemplary implementation, the polymer includes a thermoplastic polymer, such as thermoplastic polyurethane (TPU), or a blend thereof. Illustrative thermoplastic polyurethanes may be or include, but are not limited to, one or more of a polyether-based thermoplastic polyurethane, an aliphatic polyether TPU, a TPU resin blend, or the like, or any combination thereof. For example, the TPU may be or include ESTANE AG-8451 TPU (an aliphatic polyether TPU commercially available from Lubrizol Corporation of Wickliffe, OH), TEXIN® 8980D (an aliphatic polyether TPU commercially available from Covestro, LLC), TECOFLEX® EG-72D (an aliphatic polyether TPU commercially available from Lubrizol Corporation of Wickliffe, OH), ESTANE® ALR TPU (an aliphatic based TPU commercially available from Lubrizol Corporation), or the like, or any combination thereof.

The one or more polymers or polymer blends may have a Shore hardness of greater than 80A. For example, the polymer or polymer blend may have a Shore hardness of greater than 80A, greater than or equal to 87A, greater than or equal to 51D, greater than or equal to 55D, greater than or equal to about 60D, greater than or equal to 67D, greater than or equal to 72D, greater than or equal to 80D, or greater than or equal to 85D. Shore hardness was measured according to the ASTM D2240.

The salt or electrolyte of the polymeric ion conductive layer 114 may be or include an alkali earth metal salt, an alkaline earth metal salt, organic salts, or any combination thereof. Illustrative salts or electrolytes may be or include, but are not limited to, one or more of lithium salts, lithium halides, lithium-metal salts, lithium chloride (LiCl), lithium fluoride (LiF), lithium iodide (LiI), lithium nitrate (LiNO₃), lithium perchlorate (LiClO₄), lithium tetrafluoroborate (LiBF₄), lithium hexafluorophosphate (LiPF₆), lithium hexafluoroarsenat (V) (LiAsF₆), lithium triflate, lithium perchlorate, lithium imide, lithium bis(trifluoromethanesulfonyl)imide (LiTFSI) salt, lithium 2-trifluoromethyl-4,5-dicyanoimidazolide (LiTDI), other lithium compounds, sodium octylsulfate, lithium dodecylbenzenesulfate, or any combination thereof. Of course, it will be recognized that other salts may be used, such as those with cations having the elements of Na, K, Cs, Mg and Ag. It is also possible employ organic salts, such as sodium octylsulfate, lithium dodecylbenzenesulfate or the like. It is also possible to employ mixtures of two or more conductive salts.

The one or more salts or electrolytes may be present in an amount of from about 1 wt % to about 25 wt % or about 40 wt %, based on the total weight of the polymeric ion conductive layer 114, or the plasticizer and the salt thereof. The one or more salts or electrolytes may be present in the plasticizer in an amount of from about 0.1 M to about 2 M, about 0.5 M to about 1.5 M, or about 1 M.

The plasticizer of the polymeric ion conductive layer 114 may be or include, but is not limited to, one or more organic solvents, such as a carbonate solvent, a lactone solvent, or the like, or any combination thereof. The organic solvent may be selected from a material that provides sufficient ionic conductivity to provide a suitable switching speed for the electrochromic device 100. The organic solvent may be or include, but is not limited to, an organic carbonate solvent, a lactone solvent, or any combination thereof. Illustrative lactone solvents may be or include, but are not limited to, propiolactones, butyrolactones, crotonolactones, valerolactones, or the like, or any mixture or combination thereof. Illustrative organic carbonate solvents may be or include, but are not limited to, diethyl carbonate, propylene carbonate, ethylene carbonate, gamma butyrolactone, dimethyl carbonate, methyl ethyl carbonate, glycerin carbonate, butylene carbonate, alkylene carbonate, or the like, or any combination thereof. In an exemplary implementation, the organic carbonate solvent includes one or more of diethyl carbonate, propylene carbonate, ethylene carbonate, or any combination thereof. Illustrative plasticizers may also be or include, but are not limited to, one or more of a benzoate, a monobenzoate, a dibenzoate, an acrylate monomer, a phthalate, an aliphatic ester, a non-aliphatic ester, an ethylene glycol bis, a trimellitate, a sebacate, an adipate, a terephthalate, a gluterate, a glyceride, an azelate, a maleate, an epoxidized soybean oil, glycols and/or polyethers, including but not limited to, triethylene glycol dihexanoate (3G6), tetraethylene glycol diheptanoate (4G7), triethylene glycol bis(2-ethyl hexanoate) (TEG-EH), tetra ethylene glycol bis(2-ethyl hexanoate) (4GEH), and polyethylene glycol bis(2-ethylhexanoate) (PEG-EH), organophosphates, including but not limited to, tricresyl phosphate (TCP) and tributyl phosphate (TBP), alkyl citrates, glycerol, acetylated monoglycerides, or the like, or any combination or mixture thereof. Additional plasticizers may be or include, but are not limited to, one or more of esters of organic acids, such as esters of adipic acid or phthalic acid, esters of inorganic acids, such as esters of boric acid, carbonic acid, sulfuric acid and phosphoric acid, ethers, such as dibutyl ether, dihexyl ether, diheptyl ether, or the like, or any combination thereof. Illustrative plasticizers may also be or include, but are not limited to, one or more of 3,3′-Oxybis(1-propanol) dibenzoate, BENZOFLEX® 9-88 SG (commercially available from Eastman Chemicals), di-trimethylolpropane tetraacrylate, triallyl isocyanurate, SR35 (commercially available from Sartomer), SR533 (commercially available from Sartomer), Rhodiasolve IRIS (an oxygenated solvent commercially available from Solvay), or the like, or any combination thereof.

In an exemplary implementation, the plasticizer may include at least one carbonic solvent and an additional plasticizer material capable of or configured to increases the optical transparency of the polymeric ion conductive layer 114. The additional plasticizer may be another organic carbonate, such as diethyl carbonate, propylene carbonate, or ethylene carbonate. In some embodiments, the plasticizer is another organic carbonate, such as diethyl carbonate, propylene carbonate or ethylene carbonate. Applicant has discovered that a selected mixture of two or more such organic carbonates reduces the overall Ra between the plasticizer and the polymer, thereby increasing the optical clarity of the electrolyte film. In one such embodiment, the plasticizer comprises a mixture of diethyl carbonate and propylene carbonate that provides sufficient conductivity and optical clarity to the electrolyte film. In an exemplary embodiment, the mixture contains about 40% to 90% by volume of the propylene carbonate, more preferably about 50% to about 85% by volume, with the remainder of the mixture substantially comprising diethyl carbonate.

In at least one implementation, the plasticizer may be or include a combination of one or more of propylene carbonate, ethylene carbonate, triethylene glycol bis(2-ethylhexanoate) (TEG-EH), or any combination thereof. In an exemplary implementation, the plasticizer may be or include a combination of propylene carbonate and triethylene glycol bis(2-ethylhexanoate) (TEG-EH). The propylene carbonate and triethylene glycol bis(2-ethylhexanoate) (TEG-EH) may be present in an amount of about 66/34% v/v, respectively. In another implementation, the plasticizer may be or include a combination of ethylene carbonate, propylene carbonate, and TEG-EH. The ethylene carbonate, propylene carbonate, and TEG-EH may be present in an amount of about 30/30/40% v/v respectively. Any of the foregoing combination of plasticizers may include the salts or electrolytes described herein. For example, the combination of ethylene carbonate, propylene carbonate, and TEG-EH in an amount of about 30/30/40% v/v may include about 1M Lithium bis(trifluoromethanesulfonyl)imide (LiTFSI) salt.

Additional combinations of plasticizers may be or include, but are not limited to: (1) a mixture of Benzoflex 9-88 SG and propylene carbonate including about 45% to about 95% Benzoflex 9-88 G (preferably 90% or less) with the remainder including propylene carbonate; (2) a mixture of Benzoflex 9-88 SG and diethyl carbonate including about 50% to about 95% Benzoflex 9-88 G (preferably 90% or less) with the remainder including diethyl carbonate; (3) a mixture of SR355 and ethylene carbonate including about 48% to about 75% SR355 with the remainder including ethylene carbonate; (4) a mixture of Benzoflex 9-88 SG and a 50/50 mixture of propylene carbonate and ethylene carbonate including about 50% to about 95% Benzoflex 9-88 G (preferably 90% or less) with the remainder including the 50/50 mix of ethylene carbonate and propylene carbonate; (5) a mixture of Benzoflex 9-88 SG and a 50/50 mixture of propylene carbonate and diethyl carbonate including about 5% to about 95% Benzoflex 9-88 G (preferably 90% or less) with the remainder including a 50/50 mix of diethyl carbonate and propylene carbonate; (6) a mixture of Benzoflex 9-88 SG and a mixture of 66/33 propylene carbonate and diethyl carbonate including about 20% to about 95% Benzoflex 9-88 G (preferably 90% or less) with the remainder including a 66/33 mix of propylene carbonate and diethyl carbonate; or (7) a mixture of Benzoflex 9-88 SG and a 33/66 mixture of propylene carbonate and diethyl carbonate including about greater than 0% Benzoflex 9-88 G to about 95% Benzoflex 9-88 G (preferably 90% or less) with the remainder of including a 33/66 mix of propylene carbonate and diethyl carbonate. It should be appreciated that any of the foregoing combinations of plasticizers are not exhaustive.

The one or more plasticizers may be present in an amount of from about 5 wt % to about 65 wt %, based on the total weight of the polymeric ion conductive layer 114. For example, the one or more plasticizers may be present in an amount of from about 5 wt %, about 20 wt %, about 30 wt %, about 35 wt %, about 40 wt %, about 45 wt %, about 50 wt %, about 55 wt %, or about 60 wt % to about 65 wt %, based on the total weight of the polymeric ion conductive layer 114. In another example, the one or more plasticizers may be present in an amount sufficient to provide the ionic conductivities described herein. In yet another implementation, the one or more plasticizers may be present in an amount of greater than or equal to about 35 wt %, greater than or equal to about 40 wt %, greater than or equal to about 45 wt %, greater than or equal to about 50 wt %, greater than or equal to about 55 wt %, or greater than or equal to about 60%, based on the total weight of the polymeric ion conductive layer 114.

In an exemplary implementation, the polymer layer is present in the electrolyte film in an amount of about 30 wt % to about 70 wt %, or about 40 wt % to about 60 wt %, or about 45 wt % to about 50 wt % based on the total weight of the polymeric ion conductive layer 114. The plasticizers are present in the film in an amount of about 30 wt % to about 70 wt %, or about 40 wt % to about 60 wt %. or about 45% to about 55%, or about 50 wt %. based on the total weight of the polymeric ion conductive layer 114.

In an exemplary embodiment, the plasticizer comprises an organic carbonate and triethylene glycol bis(2-ethyl hexanoate) (TEG-EH). In an exemplary embodiment, the organic carbonate comprises propylene carbonate. In another embodiment, the plasticizer may include a combination of ethylene carbonate, propylene carbonate, and triethylene glycol bis(2-ethylhexanoate) (TEG-EH). In embodiments, the second material has a volume percentage of about 20% to about 80%, or about 20% to about 40%, or about 30% to about 35% or about 34% of the plasticizer. The organic carbonate has a volume percentage of about 20% to about 80%, or about 60% to about 80% or about 65% to about 70%, or about 66% of the plasticizer

The polymeric ion conductive layer 114 and/or the one or more components thereof may include one or more additives. For example, the plasticizer may include one or more additives. The additives may be or include one or more of a UV stabilizer or blocker, such as for example UVINUL® or IRGASTAB®, antioxidants, such as IRGANOX®, ULTRANOX® or SICOSTAB®, viscosity modifiers, dispersion auxiliaries, photoinitiators, or the like, or any combination thereof. In another example, the polymeric ion conductive layer 114 may include one or more ionic liquid additives capable of or configured to increase the ionic conductivity of the polymeric ion conductive layer 114 or the plasticizer thereof. Illustrative ionic liquids may be or include, but are not limited to, one or more of 1-Butyl-1-methylpyrrolidinium bis(trifluoromethylsulfonyl)imide ([PYR14][TFSI]), 1-ethyl-3-methylimidazolium, bis[(trifluoromethyl)sulfonyl]imide ([C2mim][TFSI]), 1-ethyl-3-methylimidazolium bis(fluorosulfonyl)imide ([C2mim][FSI]), 1-butyl-3-methylimidazolium bis(trifluoromethylsulfonyl)imide (C4mim][TFSI]), 1-butyl-3-methyl-imidazolium bis(fluorosulfonyl)imide (C4mim][FSI]), or the like, or combinations thereof. One or more nanomaterials may also be included in the polymeric ion conductive layer 114 to enhance ionic conductivity and/or increase a mechanical strength thereof. These are solids that will not dissociate when added to the plasticizer. They can be incorporated via mechanical homogenization techniques including but not limited to high intensity agitation, sonication, dry or wet milling, surfactant-assisted wet milling etc. Illustrative nanomaterials may be or include, but are not limited to, SiO₂, ZrO₂, Al₂O₃, LiLaTiO₃, or the like, or any combination thereof.

In one implementation, the difference between a Hansen Solubility Parameter of the polymer and a Hansen Solubility Parameter of the plasticizer of the polymeric ion conductive layer 114 may be less than or equal to about 5, less than or equal to about 4.5, less than or equal to about 4, less than or equal to about 3.8, less than or equal to about 3.5, less than or equal to about 3, or less than or equal to about 2.5. As used herein, the Hansen Solubility Parameter may be determined by HSPiP version 5.3.04 software and is used to predict if two or more materials are soluble and/or compatible with one another. Further, as used herein, a difference between a Hansen Solubility Parameter of a first material or substance and a Hansen Solubility Parameter of a second material or substance, may be referred to as an HSP Distance or “Ra”. The Ra of mixed plasticizers vs TPU was calculated as described in U.S. Pat. No. 12,032,260, previously incorporated herein by reference.

Laminates including the electrochromic device 100 described herein are also described. The laminates and/or the electrochromic device 100 described herein may be utilized in or as a window, a glass panel, a glazing, and/or an energy harvesting structural laminated glazing unit (LGU), optical shutters, color changing or changeable eyewear, welding visors, in various applications and/or industries including, but not limited to, architectural, vehicle, or transportation application and industries. Illustrative applications may be or include, but are not limited to, an automobile or a locomotive windshield, rear window or sunroof, an airplane window or canopy, windows in a residential or commercial building, balustrades, balconies and stairs, a decorative panel or covering for walls, columns, an elevator, other architectural applications, a cover for signs, a display, an appliance, an electronic device, furniture, or the like. As used herein, the term “glazing” or “laminate” may refer to a transparent, semi-transparent, translucent, or opaque window, panel, wall, or other structure, or a portion/part thereof having at least one optically transparent sheet (e.g., rigid outer ply, glass sheet, polymeric sheet, etc.) laminated or otherwise coupled with another optically transparent sheet via an interlayer. For example, the laminate may be a clear or tinted laminated glass. The laminates may have a transmittance to visible light of greater than about 80%, and preferably greater than about 85%, and a switching speed of less than 5 min, less than 1 min, or less than 30 sec.

### EXAMPLES

The examples and other implementations described herein are exemplary and not intended to be limiting in describing the full scope of compositions and methods described herein. Equivalent changes, modifications, and variations of specific implementations, materials, compositions, and methods may be made within the scope of the implementations or embodiments described herein, with substantially similar results.

### Example 1

Exemplary polymeric ion conductive interlayers (1)-(8) were prepared and evaluated. Specifically, exemplary polymeric ion conductive interlayers (1)-(8) having a thickness of about 0.015 inches (about 0.381 mm) were prepared by combining a thermoplastic polyurethane having a Shore hardness of about 80A with varying amounts of a plasticizer according to Table 1. Each of the polymeric ion conductive interlayers (1)-(8) was evaluated for ionic conductivity, light transmission, haze, and creep. Ion conductivity was measured via electrochemical impedance spectroscopy that evaluated between a starting frequency of about 1 MHz and an ending frequency of about 1 Hz at a sampling interval of about 1 second(s) using a potentiostat commercially available from Admiral instruments of Tempe, AZ. Light transmission and haze were measured according to reference test ASTM-D1003 of the American Society for Testing and Materials (ASTM). Shore hardness was measured according to the ASTM D2240.

Creep was evaluated on post-autoclaved laminates prepared from two glass substrates or panels, one measuring 4″×3″ and the other measuring 3″×3″, coupled or laminated with one another via each of the respective polymeric ion conductive interlayers (1)-(8). The laminates were suspended by securing a first glass substrate (4″×3″) while allowing the second glass substrate (3″×3″) to freely slide under its own weight. The laminates were evaluated in a convention oven maintained at a temperature of about 85° C. for about 24 hours. The results are summarized in Table 2.

TABLE 1
Polymeric Ion Conductive Interlayers (1)-(8)

| Component | (1) | (2) | (3) | (4) | (5) | (6) | (7) | (8) |
|---|---|---|---|---|---|---|---|---|
| TPU (80A Hardness)¹ | Bal. | Bal. | Bal. | Bal. | Bal. | Bal. | Bal. | Bal. |
| (wt %) | | | | | | | | |
| Plasticizer² | 0 | 5 | 10 | 15 | 22 | 29 | 35 | — |
| (wt %) | | | | | | | | |
| Plasticizer³ | — | — | — | — | — | — | — | 35 |
| (wt %) | | | | | | | | |
| Total Components | 100 | 100 | 100 | 100 | 100 | 100 | 100 | 100 |
| (wt %) | | | | | | | | |

¹Estane AG-8451 resin: aliphatic polyether TPU having a Shore hardness of about 80A and containing an adhesion promoter.
²Plasticizer blend including 66/34% v/v propylene carbonate and triethylene glycol bis(2-ethylhexanoate) (TEG-EH) and 1M Lithium bis(trifluoromethanesulfonyl)imide (LiTFSI) salt.
³Plasticizer blend including 30/30/40% v/v ethylene carbonate, propylene carbonate, and TEG-EH and 1M LiTFSI salt.

TABLE 2
Properties of Ion Conductive Interlayers (1)-(8)

| | (1) | (2) | (3) | (4) | (5) | (6) | (7) | (8) |
|---|---|---|---|---|---|---|---|---|
| Ionic Conductivity | — | — | — | — | — | — | 1.31E−5 | — |
| (S/cm) | | | | | | | | |
| Light Transmission | 92.9² | 91.8² | 93.1² | 93.0² | 92.7² | 93.2² | 84³ | — |
| (%) | | | | | | | | |
| Haze | 1.08 | 1.21 | 0.89 | 1.05 | 0.95 | 1.02 | 1.86 | — |
| (%) | | | | | | | | |
| Δ Creep Left | 0 | 0 | 0 | 0 | 0 | 1 | Fail¹ | Fail¹ |
| (mm) | | | | | | | | |
| Δ Creep Right | 0 | 0 | 0 | 0 | 0 | 1 | Fail¹ | Fail¹ |
| (mm) | | | | | | | | |

¹Complete delamination.
²Laminated between clear borosilicate glass.
³Laminated between conductive glass.

As indicated in Table 2, the polymeric ion conductive interlayers (1)-(5) utilizing a combination of a TPU having a Shore hardness of about 80A and the plasticizer in an amount from 0 wt % to about 22 wt % resulted in no creep. As further indicated in Table 2, the polymeric ion conductive interlayer (6) including about 29% of the plasticizer exhibited a measurable amount of creep of about 1 mm. The polymeric ion conductive interlayer (7) including about 35% of the plasticizer exhibited a total failure. Particularly, the free-sliding glass panel completely delaminated from the polymeric ion conductive interlayer (7). It was surprisingly and unexpectedly discovered that utilizing a different plasticizer in an amount of about 35%, as demonstrated in the polymeric ion conductive interlayer (8), also resulted in complete delamination of the free-sliding glass panel in less than three hours.

### Example 2

Exemplary polymeric ion conductive interlayers (9)-(13) were prepared and evaluated. Specifically, exemplary polymeric ion conductive interlayers (9)-(13) having a thickness of about 0.015 inches (about 0.381 mm) were prepared by combining a thermoplastic polyurethane blend with varying amounts of a plasticizer according to Table 3. The thermoplastic polyurethane blend included 50/50 wt % TEXIN® 8980D and TECOFLEX® EG-72D. TEXIN® 8980D is an aliphatic polyether TPU having a Shore hardness of about 80D, which is commercially available from Covestro LLC of Pittsburgh, PA. TECOFLEX EG-72D is an aliphatic polyether TPU having a Shore hardness of about 67D, which is commercially available from Lubrizol Corporation of Wickliffe, OH. The TPU resin blend had a combined Shore hardness of about 80D/67D, which is relatively higher than the 80A hardness of the TPU of Example 1. Shore hardness was measured according to the ASTM D2240. Each of the polymeric ion conductive interlayers (9)-(13) was evaluated for ionic conductivity, light transmission, haze, and creep according to the same procedure as Example 1. The results are summarized in Table 4.

TABLE 3
Polymeric Ion Conductive Interlayers (9)-(13)

| Component | (9) | (10) | (11) | (12) | (13) |
|---|---|---|---|---|---|
| TPU (80D/67D Hardness)¹ | Bal. | Bal. | Bal. | Bal. | Bal. |
| (wt %) | | | | | |
| Plasticizer² | 35 | 40 | 45 | 50 | — |
| (wt %) | | | | | |
| Plasticizer³ | — | — | — | — | 35 |
| (wt %) | | | | | |
| Total Components | 100 | 100 | 100 | 100 | 100 |
| (wt %) | | | | | |

¹TPU resin blend including 50/50 wt % TEXIN ® 8980D and TECOFLEX ® EG-72D.
²Plasticizer blend including 66/34% v/v propylene carbonate and triethylene glycol bis(2-ethylhexanoate) (TEG-EH) and 1M Lithium bis(trifluoromethanesulfonyl)imide (LiTFSI) salt.
³Plasticizer blend including 30/30/40% v/v ethylene carbonate, propylene carbonate, and TEG-EH and 1M LiTFSI salt.

TABLE 4
Properties of Ion Conductive Interlayers (9)-(13)

| | (9) | (10) | (11) | (12) | (13) |
|---|---|---|---|---|---|
| Ionic Conductivity | 3.61E−6 | — | — | 2.21E−4 | 1.66E−6 |
| (S/cm) | | | | | |
| Light Transmission | 83.1² | 92.9¹ | 93.0¹ | 83.2² | 78.8² |
| (%) | | | | | |
| Haze | 2.12 | 1.49 | 1.19 | 1.39 | 2.17 |
| (%) | | | | | |
| Δ Creep Left | 0 | 0 | 0 | 0 | 0 |
| (mm) | | | | | |
| Δ Creep Right | 0 | 0 | 0 | 0 | 0 |
| (mm) | | | | | |

¹Laminated between clear borosilicate glass.
²Laminated between conductive glass.

As indicated in Table 4, the polymeric ion conductive interlayer (9) including about 35% of the plasticizer exhibited no creep as compared to the polymeric ion conductive interlayer (7), which also included about 35% of the same plasticizer. It was observed that the polymeric ion conductive interlayers (9)-(12) were relatively stiffer than the polymeric ion conductive interlayers (1)-(8) of Example 1. However, as further indicated in Table 4, the ionic conductivity of the polymeric ion conductive interlayer (9) was about 3.61E-6 S/cm, which was approximately a third of the ionic conductivity observed in the polymeric ion conductive interlayer (7) of Example 1. It was surprisingly and unexpectedly discovered that utilizing a different plasticizer in an amount of about 35 wt %, as demonstrated in the polymeric ion conductive interlayer (13), provided results that were parity or comparable with the polymeric ion conductive interlayers (9)-(12); and thus, exhibited no creep. It was further surprisingly and unexpectedly discovered that the polymeric ion conductive interlayer (12), which included about 50 wt % of the plasticizer exhibited a significant increase in ion conductivity as compared to the polymeric ion conductive interlayer (9). Particularly, it was demonstrated that the polymeric ion conductive interlayer (12) exhibited an ion conductivity of about 17× greater than the polymeric ion conductive interlayer (7) and about 61× greater than the polymeric ion conductive interlayer (9).

### Example 3

Exemplary polymeric ion conductive interlayers (14)-(15) were prepared and evaluated. Specifically, exemplary polymeric ion conductive interlayers (14)-(15) having a thickness of about 0.015 inches (about 0.381 mm) were prepared by combining a thermoplastic polyurethane with varying amounts of a plasticizer according to Table 5. The thermoplastic polyurethane was ESTANE® ALR TPU, an aliphatic based TPU having a Shore hardness of about 60D, which is commercially available from Lubrizol Corporation of Wickliffe, OH. Each of the polymeric ion conductive interlayers (14)-(15) was evaluated for ionic conductivity, light transmission, haze, and creep according to the same procedure as Example 1. Shore hardness was measured according to the ASTM D2240. The results are summarized in Table 6.

TABLE 5
Polymeric Ion Conductive Interlayers (14)-(15)

| Component | (14) | (15) |
|---|---|---|
| TPU (60D Hardness)¹ | Bal. | Bal. |
| (wt %) | | |
| Plasticizer² | 50 | 50 |
| (wt %) | | |
| Total Components | 100 | 100 |
| (wt %) | | |

¹Estane ALR CLC60D: aliphatic polyether TPU having a Shore hardness of about 60D.
²Plasticizer blend including 66/34% v/v propylene carbonate and triethylene glycol bis(2-ethylhexanoate) (TEG-EH) and 1M Lithium bis(trifluoromethanesulfonyl)imide (LiTFSI) salt.

TABLE 6
Properties of Ion Conductive Interlayers (14)-(15)

| | (14) | (15) |
|---|---|---|
| Ionic Conductivity | 1.274E−4 | 1.580E−4 |
| (S/cm) | | |
| Light Transmission | 83.9¹ | 84.1¹ |
| (%) | | |
| Haze | 1.82 | 1.28 |
| (%) | | |
| Δ Creep Left | 0 | 0 |
| (mm) | | |
| Δ Creep Right | 0 | 0 |
| (mm) | | |

¹Laminated between conductive glass.

As indicated in Table 6, the polymeric ion conductive interlayers (14) and (15), which utilized a TPU having a Shore hardness of about 60D also exhibited no creep. The polymeric ion conductive interlayers (14) and (15) also exhibited ionic conductivities in the same magnitude as the polymeric ion conductive interlayer (12).

### Example 4

Applicant conducted further testing of exemplary polymeric ion conductive interlayers for light transmittance and switching speed from the clear state (T_{clear}) and the shaded state (T_{dark}). The samples all comprised 50% w Elastollan L760D and 50% w plasticizer. Elastollan L760D is an aliphatic polyester based TPU having shore hardness of about 60D, which is commercially available from BASF, Germany. The plasticizer comprised a 66/34v propylene carbonate/TEG-EH plasticizer blend containing 1 M liTFSI salt. The exemplary polymeric ion conductive interlayers have a thickness of about 0.015 inches (about 0.381 mm). Each of the polymeric ion conductive interlayers was evaluated for ionic conductivity, light transmission, haze, switching speed and creep according to the same procedure as described above. Shore hardness was measured according to the ASTM D2240.

Sample 1 produced a light transmittance of 65% in the clear state and 10% in the shaded state after more than 3,000 cycles under ambient conditions. The same sample produced light transmittance of 62% in the clear state and 13% in the shaded state after more than 2,100 Q-SUN cycles. The switching speed was reported to be approximately 6 minutes under both ambient and Q-SUN conditions. Sample 1 further yielded an ionic conductivity of 3.93×10⁻⁴ S/cm without any additional drying.

Sample 2 produced a light transmittance of 68% in the clear state and 10% in the shaded state after more than 500 cycles under ambient conditions. The same sample produced light transmittance of 65% in the clear state and 13% in the shaded state after more than 1,500 Q-SUN cycles. The switching speed was reported to be approximately 6 minutes under both ambient and Q-SUN conditions.

Sample 3 produced a light transmittance of 70% in the clear state and 10% in the shaded state after more than 700 cycles under ambient conditions. The same sample produced light transmittance of 70% in the clear state and 10% in the shaded state after more than 880 Q-SUN cycles. The switching speed was reported to be approximately 6 minutes under both ambient and Q-SUN conditions when the sheet moisture was approximately 250 ppm. Sample A was cast on a 5 mil polypropylene carrier and employed a blue interleaf.

Sample 4 produced a light transmittance of 67% in the clear state and 10% in the shaded state after more than 700 cycles under ambient conditions. The same sample produced light transmittance of 67% in the clear state and 10% in the shaded state after more than 300 Q-SUN cycles. The switching speed was reported to be approximately 6 minutes under both ambient and Q-SUN conditions when the sheet moisture was approximately 470 ppm. Sample C was cast on a 5 mil polypropylene carrier and employed a 5 mil polypropylene carrier on the other side. Samples 3 and 4 yielded an ionic conductivity of approximately 1.5×10⁻⁵ S/cm when dried to a moisture content of less than 2,000 ppm.

As seen from the above samples 1-4, the light transmittance window was fairly repetitive and fixed-in 60-70% range in clear state and 10-15% range in the shaded state. None of these formulations allowed maximum light transmittance (Tclear) to be less than 60% or the minimum light transmittance (Tdark) to be less than 10%. A more complete description of the results of this testing can be found in U.S. Provisional Application Ser. No. 63/593,685, previously incorporated herein by reference.

### Example 5

As discussed above, Applicant has now been surprisingly discovered that addition of a passive tinting additive to the base formulations described above can enable electrochromic interlayer formulations with significantly enhanced flexibility with respect to the light transmission window without jeopardizing switching speed or weatherability. In the following examples, exemplary polymeric ion conductive interlayers were tested for light transmittance and switching speed from the clear state (T_{clear}) and the shaded state (T_{dark}). The samples all comprised a blend of Elastollan L760D and a plasticizer comprising 66/34v propylene carbonate/TEG-EH plasticizer blend containing 1 M liTFSI salt. The tinting agent was carbon black. In each of these samples, a passive tinting concentrate was added to the plasticizer. The concentrations by weight of the aliphatic polyether TPU, the plasticizer and the tinting concentrate all provided below in Table 7.

TABLE 7

| Sample | Elastollan L760D | Plasticizer | Tinting Concentrate |
|---|---|---|---|
| Sample 5 | 45.5% wt | 50% wt | 4.5% wt |
| Sample 6 | 48.0% wt | 50% wt | 2.0% wt |
| Sample 7 | 48.6% wt | 50% wt | 1.4% wt |

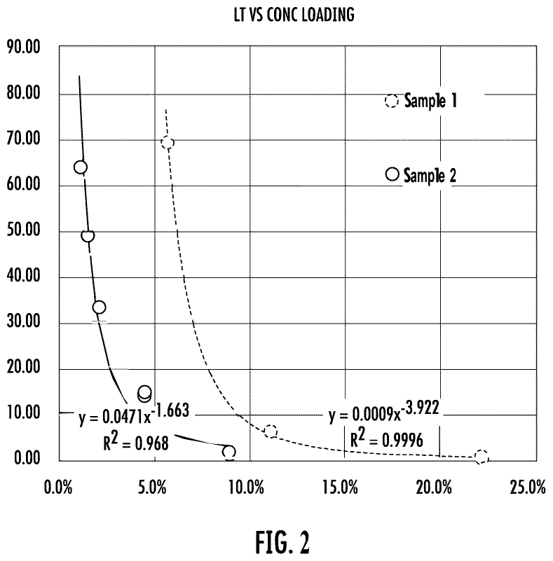

As shown in FIG. 2, by adjusting the concentration of the passive tinting agent, the T_{clear} light transmittance can be reduced to levels significantly below 60%. All tinting agents were carbon black at 1-3% w loading.

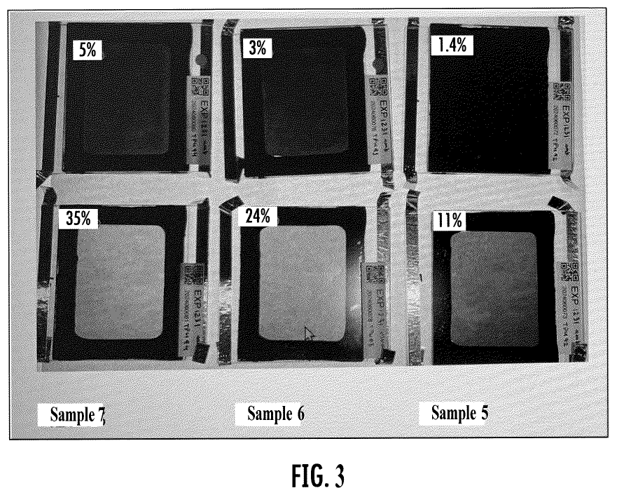

As shown in FIG. 3, Sample 5 produced a light transmittance of 11% in the clear state and 1.4% in the shaded state. Sample 6 produced a light transmittance of 24% in the clear state and 3.0% in the shaded state. Sample 7 produced a light transmittance of 35% in the clear state and 5.0% in the shaded state. When voltage is applied, samples 5-7 produce light transmittance in the T_{dark} state well below 15%. All three samples 5-7 laminated well to the glass electrodes and had a switching time (T_{clear} to T_{dark}) of approximately 3 minutes and performed well in weatherability testing. Thus, these samples illustrate that the formulations described herein produces a passively tinted and ionically conductive polymer interlayer that can offer additional flexibility to adjust the switching window (T_{clear} to T_{dark} to T_{clear}) beyond what is achievable with previous formulations.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is an electrolyte film comprising a polymer layer, an electrolyte within the polymer layer, wherein the electrolyte comprises a salt and a plasticizer, and a tinting agent within the polymer layer.

A second embodiment is the first embodiment, wherein the tinting agent is present in an amount of about 0.1% to about 10% wt %, based on the total weight of the polymer layer.

A third embodiment is any combination of the first two embodiments, wherein the tinting agent is present in an amount of about 0.5% to about 5% wt %, based on the total weight of the polymer layer.

A 4th embodiment is any combination of the first 3 embodiments, wherein the tinting agent is present in an amount of about 1.4% to about 4.5% wt %, based on the total weight of the polymer layer.

A 5^{th} embodiment is any combination of the first 4 embodiments, wherein the tinting agent comprises an inorganic pigment.

A 6^{th} embodiment is any combination of the first 5 embodiments, wherein the polymer comprises a Shore hardness of greater than about 87A.

A 7^{th} embodiment is any combination of the first 6 embodiments, wherein the polymer comprises a Shore hardness of greater than or equal to about 55D.

An 8^{th} embodiment is any combination of the first 7 embodiments, wherein the polymer is present in an amount of about 40% to about 60% wt %, based on the total weight of the polymer layer.

A 9^{th} embodiment is any combination of the first 8 embodiments, wherein the polymer is present in an amount of about 45 to about 49% wt %, based on the total weight of the polymer layer.

A 10^{th} embodiment is any combination of the first 9 embodiments, wherein the plasticizer is present in an amount of about 40% to about 60% wt %, based on the total weight of the polymer layer.

An 11^{th} embodiment is any combination of the first 10 embodiments, wherein the plasticizer is present in an amount of about 50 wt %, based on the total weight of the polymer layer.

A 12^{th} embodiment is any combination of the first 11 embodiments, wherein the plasticizer comprises an organic carbonate.

A 13^{th} embodiment is any combination of the first 12 embodiments, wherein the organic carbonate is selected from the group consisting of diethyl carbonate, propylene carbonate, ethylene carbonate, gamma-butyrolactone, dimethyl carbonate, methyl ethyl carbonate, glycerin carbonate, butylene carbonate, alkylene carbonate and combinations thereof.

A 14^{th} embodiment is any combination of the first 13 embodiments, wherein the plasticizer comprises an organic carbonate and a second material selected from the group consisting of a benzoate, a monobenzoate, a dibenzoate, an acrylate monomer, a phthalate, an aliphatic ester, a non-aliphatic ester, an ethylene glycol bis, a trimellitate, a sebacate, an adipate, a terephthalate, a gluterate, a glyceride, an azelate, a maleate, an epoxidized soybean oil, glycols and/or polyether, triethylene glycol dihexanoate (3G6), tetraethylene glycol diheptanoate (4G7), triethylene glycol bis(2-ethyl hexanoate) (TEG-EH), tetra ethylene glycol bis(2-ethyl hexanoate) (4GEH), polyethylene glycol bis(2-ethylhexanoate) (PEG-EH), an organophosphate tricresyl phosphate (TCP), tributyl phosphate (TBP), alkyl citrates, glycerol, acetylated monoglycerides and combinations thereof.

A 15^{th} embodiment is any combination of the first 14 embodiments, wherein the plasticizer comprises an organic carbonate and triethylene glycol bis(2-ethyl hexanoate) (TEG-EH).

A 16^{th} embodiment is any combination of the first 15 embodiments, wherein the organic carbonate comprises propylene carbonate.

A 17^{th} embodiment is any combination of the first 16 embodiments, wherein the second material has a volume percentage of about 20% to about 80% of the plasticizer and the organic carbonate has a volume percentage of about 20% to about 80% of the plasticizer.

An 18^{th} embodiment is any combination of the first 17 embodiments, wherein the second material has a volume percentage of about 20% to about 40% of the plasticizer and the organic carbonate has a volume percentage of about 60% to about 80% of the plasticizer.

A 19^{th} embodiment is any combination of the first 18 embodiments, wherein the second material has a volume percentage of about 30% to about 35% of the plasticizer and the organic carbonate has a volume percentage of about 65% to about 70% of the plasticizer.

A 20^{th} embodiment is any combination of the first 19 embodiments, wherein the salt is a lithium salt.

A 21^{st} embodiment is any combination of the first 20 embodiments, wherein an Ra between the plasticizer and the polymer layer is less than about 5.

A 22^{nd} embodiment is any combination of the first 21 embodiments, wherein the Ra is less than or equal to 3.79.

A 23^{rd} embodiment is any combination of the first 22 embodiments, wherein the electrolyte is substantially liquid.

A 24^{th} embodiment is any combination of the first 23 embodiments, wherein the electrolyte is a gel.

A 25^{th} embodiment is any combination of the first 24 embodiments, wherein the polymer layer comprises a liquid electrolyte concentration of at least about 30% by weight of the polymer layer.

A 26^{th} embodiment is any combination of the first 25 embodiments, wherein the polymer layer comprises a thermoplastic polyurethane (TPU).

A 27^{th} embodiment is any combination of the first 26 embodiments, wherein the electrolyte film exhibits no creep as measured at about 85° C. for at least 24 hours.

A 28^{th} embodiment is any combination of the first 27 embodiments, wherein the inorganic pigment is selected from the group consisting of anthraquinone, diazo benzimidazolone, isoindolinone, quinacridone and phthalocyanine and combinations thereof.

A 29^{th} embodiment is any combination of the first 28 embodiments, wherein the inorganic pigment comprises carbon black.

A 30^{th} embodiment is any combination of the first 29 embodiments, wherein the carbon black has a particle size of about 50 nm to about 150 nm.

In another aspect, a first embodiment is an electrochromic cell comprising the electrolyte film of any combination of the above 27 embodiments.

A second embodiment is the first embodiment, wherein the electrochromic cell has a switching speed from a first state to a second state of less than about 6 minutes, wherein the first state has a greater light transmittance than the second state.

A third embodiment is any combination of the first two embodiments, wherein the switching speed is about 3 minutes.

A 4^{th} embodiment is any combination of the first 3 embodiments, wherein the cell has a light transmittance in the first state of less than about 60% and a light transmittance in the second state of less than about 15%.

In another aspect, a window comprises the electrochromic cell of any combination of the above 4 embodiments.

In another aspect, a first embodiment is an electrochromic cell comprising first and second layers of an optically transparent material and an electrolyte film between the first and second layers. The electrolyte film comprises a polymer layer, a plasticizer and a tinting agent.

A second embodiment is the first embodiment, wherein the cell has a switching speed from a first state to a second state of less than about 6 minutes, wherein the first state has a greater light transmittance than the second state.

A third embodiment is any combination of the first two embodiments, wherein the switching speed is about 4 minutes.

A 4^{th} embodiment is any combination of the first three embodiments, wherein the switching speed is about 3 minutes.

A 5^{th} embodiment is any combination of the first 4 embodiments, wherein the cell has a light transmittance in the first state of less than about 60%.

A 6^{th} embodiment is any combination of the first 5 embodiments, wherein the cell has a light transmittance in the first state of less than about 50%.

A 7^{th} embodiment is any combination of the first 6 embodiments, wherein the cell has a light transmittance in the first state of less than about 30%.

An 8^{th} embodiment is any combination of the first 7 embodiments, wherein the cell has a light transmittance in the second state of less than about 15%.

A 9^{th} embodiment is any combination of the first 8 embodiments, wherein the cell has a light transmittance in the second state of less than about 10%.

A 10^{th} embodiment is any combination of the first 9 embodiments, wherein the cell has a light transmittance in the second state of less than about 5%.

An 11^{th} embodiment is any combination of the first 10 embodiments, wherein the film an ionic conductivity of at least about 1.5×10⁻⁵ Siemens/cm.

A 12^{th} embodiment is any combination of the first 11 embodiments, wherein the film an ionic conductivity of at least about 3.93×10⁻⁴ Siemens/cm.

A 13^{th} embodiment is any combination of the first 12 embodiments, wherein the tinting agent is present in an amount of about 0.1% to about 10% wt %, based on the total weight of the polymer layer.

A 14^{th} embodiment is any combination of the first 13 embodiments, wherein the tinting agent is present in an amount of about 0.5% to about 5% wt %, based on the total weight of the polymer layer.

A 15^{th} embodiment is any combination of the first 14 embodiments, wherein the tinting agent is present in an amount of about 1.4% to about 4.5% wt %, based on the total weight of the polymer layer.

A 16^{th} embodiment is any combination of the first 15 embodiments, wherein the tinting agent comprises an inorganic pigment.

A 17^{th} embodiment is any combination of the first 16 embodiments, wherein the plasticizer comprises an organic carbonate.

An 18^{th} embodiment is any combination of the first 17 embodiments, wherein the organic carbonate is selected from the group consisting of diethyl carbonate, propylene carbonate, ethylene carbonate, gamma-butyrolactone, dimethyl carbonate, methyl ethyl carbonate, glycerin carbonate, butylene carbonate, alkylene carbonate and combinations thereof.

A 19^{th} embodiment is any combination of the first 18 embodiments, wherein the plasticizer comprises an organic carbonate and a second material selected from the group consisting of a benzoate, a monobenzoate, a dibenzoate, an acrylate monomer, a phthalate, an aliphatic ester, a non-aliphatic ester, an ethylene glycol bis, a trimellitate, a sebacate, an adipate, a terephthalate, a gluterate, a glyceride, an azelate, a maleate, an epoxidized soybean oil, glycols and/or polyether, triethylene glycol dihexanoate (3G6), tetraethylene glycol diheptanoate (4G7), triethylene glycol bis(2-ethyl hexanoate) (TEG-EH), tetra ethylene glycol bis(2-ethyl hexanoate) (4GEH), polyethylene glycol bis(2-ethylhexanoate) (PEG-EH), an organophosphate tricresyl phosphate (TCP), tributyl phosphate (TBP), alkyl citrates, glycerol, acetylated monoglycerides and combinations thereof.

A 20^{th} embodiment is any combination of the first 19 embodiments, wherein the plasticizer comprises an organic carbonate and triethylene glycol bis(2-ethyl hexanoate) (TEG-EH).

A 21^{st} embodiment is any combination of the first 10 embodiments, wherein the organic carbonate comprises propylene carbonate.

A 22^{nd} embodiment is any combination of the first 21 embodiments, wherein the inorganic pigment is selected from the group consisting of anthraquinone, diazo benzimidazolone, isoindolinone, quinacridone and phthalocyanine and combinations thereof.

A 23^{rd} embodiment is any combination of the first 22 embodiments, wherein the inorganic pigment comprises carbon black.

A 24^{th} embodiment is any combination of the first 23 embodiments, wherein the carbon black has a particle size of about 50 nm to about 150 nm.

In another aspect, a window comprises the electrochromic cell of any combination of the above 21 embodiments.

What is claimed is:

1. An electrolyte film comprising:
a polymer layer;
an electrolyte within the polymer layer, wherein the electrolyte comprises a salt and a plasticizer; and
a tinting agent within the polymer layer.

2. The film of claim 1, wherein the tinting agent comprises an inorganic pigment.

3. The film of claim 2, wherein the inorganic pigment is selected from the group consisting of anthraquinone, diazo benzimidazolone, isoindolinone, quinacridone and phthalocyanine and combinations thereof.

4. The film of claim 2, wherein the inorganic pigment comprises carbon black.

5. The film of claim 4, wherein the carbon black has a particle size of about 50 nm to about 150 nm.

6. The film of claim 1, wherein the tinting agent is present in an amount of about 0.1% to about 10% wt %, based on the total weight of the polymer layer.

7. The film of claim 1, wherein the polymer layer comprises a polymer present in an amount of about 40 wt % to about 60% wt %, based on the total weight of the polymer layer.

8. The film of claim 1, wherein the plasticizer is present in an amount of about 40 wt % to about 60% wt %, based on the total weight of the polymer layer.

9. The film of claim 1, wherein the plasticizer comprises an organic carbonate, wherein the organic carbonate is selected from the group consisting of diethyl carbonate, propylene carbonate, ethylene carbonate, gamma-butyrolactone, dimethyl carbonate, methyl ethyl carbonate, glycerin carbonate, butylene carbonate, alkylene carbonate and combinations thereof.

10. The film of claim 1, wherein the plasticizer comprises an organic carbonate and a second material selected from the group consisting of a benzoate, a monobenzoate, a dibenzoate, an acrylate monomer, a phthalate, an aliphatic ester, a non-aliphatic ester, an ethylene glycol bis, a trimellitate, a sebacate, an adipate, a terephthalate, a gluterate, a glyceride, an azelate, a maleate, an epoxidized soybean oil, glycols and/or polyether, triethylene glycol dihexanoate (3G6), tetraethylene glycol diheptanoate (4G7), triethylene glycol bis(2-ethyl hexanoate) (TEG-EH), tetra ethylene glycol bis(2-ethyl hexanoate) (4GEH), polyethylene glycol bis(2-ethylhexanoate) (PEG-EH), an organophosphate tricresyl phosphate (TCP), tributyl phosphate (TBP), alkyl citrates, glycerol, acetylated monoglycerides and combinations thereof.

11. The film of claim 1, wherein the plasticizer comprises an organic carbonate and triethylene glycol bis(2-ethyl hexanoate) (TEG-EH).

12. The film of claim 11, wherein the organic carbonate comprises propylene carbonate.

13. The film of claim 10, wherein the second material has a volume percentage of about 20% to about 80% of the plasticizer and the organic carbonate has a volume percentage of about 20% to about 80% of the plasticizer.

14. The film of claim 1, wherein an Ra between the plasticizer and the polymer layer is less than about 5.

15. An electrochromic cell comprising:
first and second layers of an optically transparent material; and
an electrolyte film between the first and second layers, the electrolyte film comprising a polymer, a plasticizer and a tinting agent.

16. The electrochromic cell of claim 15, wherein the cell has a switching speed from a first state to a second state of less than about 6 minutes, wherein the first state has a greater light transmittance than the second state.

17. The electrochromic cell of claim 15, wherein the cell has a light transmittance in the first state of less than about 60%.

18. The electrochromic cell of claim 15, wherein the cell has a light transmittance in the second state of less than about 10%.

19. The electrochromic cell of claim 15, wherein the tinting agent is present in an amount of about 0.1% to about 10% wt %, based on the total weight of the electrolyte film.

20. The electrochromic cell of claim 15, wherein the tinting agent comprises an inorganic pigment selected from the group consisting of anthraquinone, diazo benzimidazolone, isoindolinone, quinacridone and phthalocyanine and combinations thereof.
